(19) United States
(12) Patent Application Publication
(10) Pub. No.: US 2026/0354621 A1
(43) Pub. Date: Nov. 12, 2026

(54) Grill Structure

(71) Applicant: Boston Foundry, Inc., Austin, TX (US)

(72) Inventors: John Bergeron, Austin, TX (US); Krista Sherman, Austin, TX (US); Justin Jones, Austin, TX (US); Eli Wiegmann, Austin, TX (US)

(21) Appl. No.: 19/201,463

(22) Filed: May 7, 2025

(51) Int. Cl. A47J 37/07

(52) U.S. Cl. CPC A47J 37/0704; A47J 37/0731; A47J 2037/0777

(57) ABSTRACT

A grill having first and second side walls, a front wall, and a back wall forming a compartment. The grill further having a grill top that is adjustable between a grilling position where the grill top substantially covers the top of the compartment, and a stowed position where the grill top is substantially within the compartment and is in a substantially vertical position.

### TECHNICAL FIELD

This disclosure relates to outdoor grills and more specifically to portable or tabletop grills.

### BACKGROUND

Outdoor grills are a common device for cooking food. Grills are available in many shapes and sizes. A portable and adjustable grill can improve the grilling process.

### BRIEF SUMMARY

The following presents a general summary of aspects of the invention in order to provide a basic understanding of the invention. This summary is not an extensive overview of the invention. It is not intended to identify key or critical elements of the invention or to delineate the scope of the invention. The following summary merely presents some concepts of the invention in a general form as a prelude to the more detailed description provided below.

Aspects of this disclosure may relate to grills and portable or tabletop grills. The grill may include a first sidewall, the first sidewall having a first slot; a second sidewall, the second sidewall having a second slot; a front wall, the front wall engaged with the first sidewall and the second sidewall; a back wall, the back wall engaged with the first sidewall and the second sidewall; a bottom wall; the first sidewall, second sidewall, the front wall, the back wall, and the bottom wall forming an internal compartment. The grill may include a grill top, the grill top having a first edge having a first peg extending from the first edge and into the first slot, a second edge having a second peg extending from the second edge and into the second slot, a front edge, and a back edge. The grill top is adjustable between a grilling position where the grill top substantially covers the top of the compartment, and a stowed position where the grill top is substantially within the compartment in a substantially vertical position.

The first sidewall and the front wall may form a first foot, the first sidewall and the back wall may form a second foot, the second sidewall and the front wall may form a third foot; and the second sidewall and the back wall may form a fourth foot. The four feet of the grill may be configured to allow the grill to rest on a surface including a tabletop.

The grill may also include a tray, the tray may be located within the compartment and may have a first handle extending through the first sidewall and a second handle extending through the second side wall, the tray being vertically adjustable within the compartment. The grill may include a first sidewall having a first tray engagement opening, and a second sidewall including a second tray engagement opening; and the first handle extends through the first tray engagement opening and the second handle extends through the second tray engagement opening. The first tray engagement opening may comprise a first plurality of notches and the second tray engagement opening may comprise a second plurality of notches; and the first handle is configured to engage the first plurality of notches and the second handle is configured to engage the second plurality of notches to allow the tray to be vertically adjustable within the compartment.

In some embodiments, the front edge of the grill top is angled downward when the grill top is in the grilling position and the front edge of the grill top is angled forward when the grill top is in the stowed position.

The grill top may be rotatable within the compartment and the grill top may be slidable within the compartment.

The grill may also include removable griddle that is configured to engage a top edge of the first sidewall and the second sidewall. In some embodiments, a portion of the grill top is configured to act as a backstop when the grill top is in the stowed position.

The grill may also include a drawer located below the tray. The drawer may extend through the front wall and may be configured to catch any debris that may fall through the grill.

Other aspects of this disclosure relate to a grill. The grill may include a first sidewall; a second sidewall; a front wall, the front wall engaged with the first sidewall and the second sidewall; a back wall, the back wall engaged with the first sidewall and the second sidewall; a bottom wall; the first sidewall, second sidewall, the front wall, the back wall, and the bottom wall form an internal compartment. The grill may include a grill top, the grill top having a first edge, a second edge, a front edge, and a back edge. The grill top may be adjustable between a grilling position where the grill top substantially covers the top of the compartment, and a stowed position where the grill top is substantially within the compartment in a substantially vertical position.

The front edge of the grill top may be angled downward when the grill top is in the grilling position and the front edge of the grill top may be angled forward when the grill top is in the stowed position.

The grill top may be engaged with the first sidewall and the second sidewall and the grill top may be rotatable and slidable relative to the first sidewall and the second sidewall.

In other aspects this disclosure relates to a grill. The grill may include a first sidewall; a second sidewall; a front wall, the front wall engaged with the first sidewall and the second sidewall; a back wall, the back wall engaged with the first sidewall and the second sidewall; a bottom wall; the first sidewall, second sidewall, the front wall, the back wall, and the bottom wall form an internal compartment. The grill may include a grill top, the grill top having a first edge, a second edge, a front edge, and a back edge, wherein the grill top is adjustable between a grilling position where the grill top substantially covers the top of the compartment, and a stowed position where the grill top is substantially within the compartment in a substantially vertical position. The grill may include a removable griddle that is configured to engage a top edge of the first sidewall and a top edge of the second sidewall when the grill top is in the stowed position. The grill top may be rotatable and slidable relative to the first sidewall and the second sidewall.

### DESCRIPTION OF THE DRAWINGS

To allow for a more full understanding of the present disclosure, it will now be described by way of example, with reference to the accompanying drawings in which:

FIG. 1 illustrates a perspective view of a grill, in accordance with aspects of the disclosure;

FIG. 2 illustrates a top view of the grill of FIG. 1, in accordance with aspects of the disclosure;

FIG. 3 illustrates a bottom view of the grill of FIG. 1, in accordance with aspects of the disclosure;

FIG. 4 illustrates a front view of the grill of FIG. 1, in accordance with aspects of the disclosure;

FIG. 5 illustrates a back view of the grill of FIG. 1, in accordance with aspects of the disclosure;

FIG. 6 illustrates a right side view of the grill of FIG. 1, in accordance with aspects of the disclosure;

FIG. 7 illustrates a left side view of the grill of FIG. 1, in accordance with aspects of the disclosure;

FIG. 8 illustrates a front cross-sectional view of the grill of FIG. 1, in accordance with aspects of the disclosure;

FIG. 9 illustrates a top cross-sectional view of the grill of FIG. 1, in accordance with aspects of the disclosure;

FIG. 10 illustrates a side cross-sectional view of the grill of FIG. 1, in accordance with aspects of the disclosure;

FIGS. 11A-11C illustrate the movement of the grill top of the grill moving between a grilling position and a stowed position, in accordance with aspects of the disclosure;

FIG. 11D illustrates the application of a removable griddle to the grill of FIGS. 11A-11C, in accordance with aspects of the disclosure;

FIG. 12 illustrates a griddle engaged with a grill, in accordance with aspects of the disclosure.

### DETAILED DESCRIPTION

While this invention is susceptible of embodiments in many different forms, there are shown in the drawings and will herein be described in detail example embodiments of the invention with the understanding that the present disclosure is to be considered as an exemplification of the principles of the invention and is not intended to limit the broad aspect of the invention to the embodiments illustrated. In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

Also, while the terms “top,” “side,” “distal,” and the like may be used in this specification to describe various example features and elements of the invention, these terms are used herein as a matter of convenience, e.g., based on the example orientations shown in the figures or the orientation during typical use. Nothing in this specification should be construed as requiring a specific three-dimensional orientation of structures in order to fall within the scope of this invention. Also, the reader is advised that the attached drawings are not necessarily drawn to scale.

In general, this disclosure relates to grills or portable grills having a movable grill top or cooking surface that may be stowed within the grill. Once the grill top is in the stowed position a user may place a griddle or other cooking surface in place of the grill top.

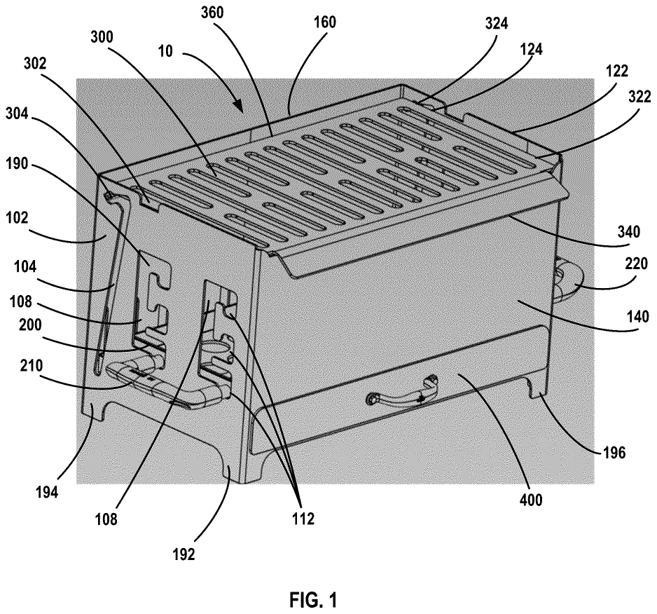

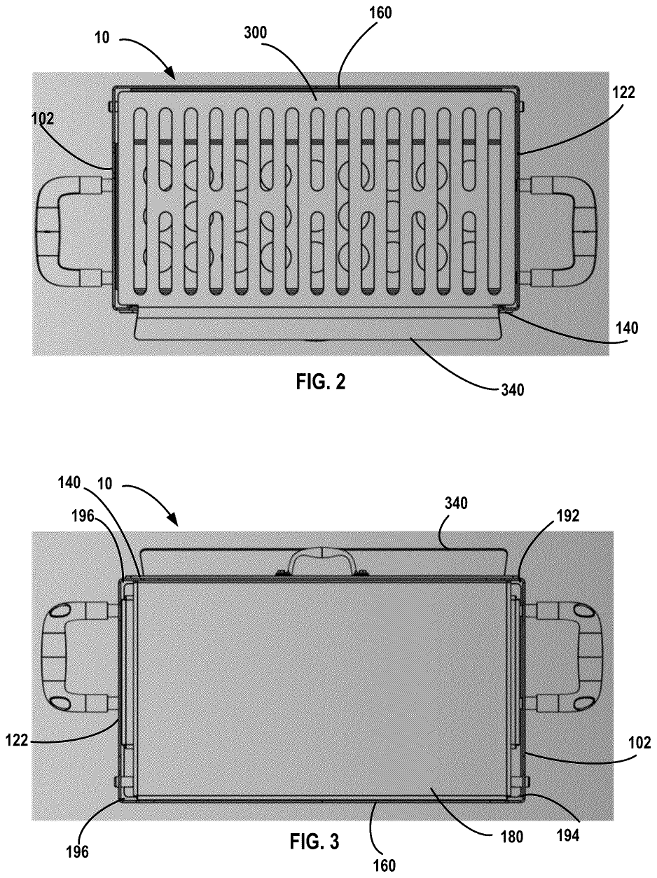

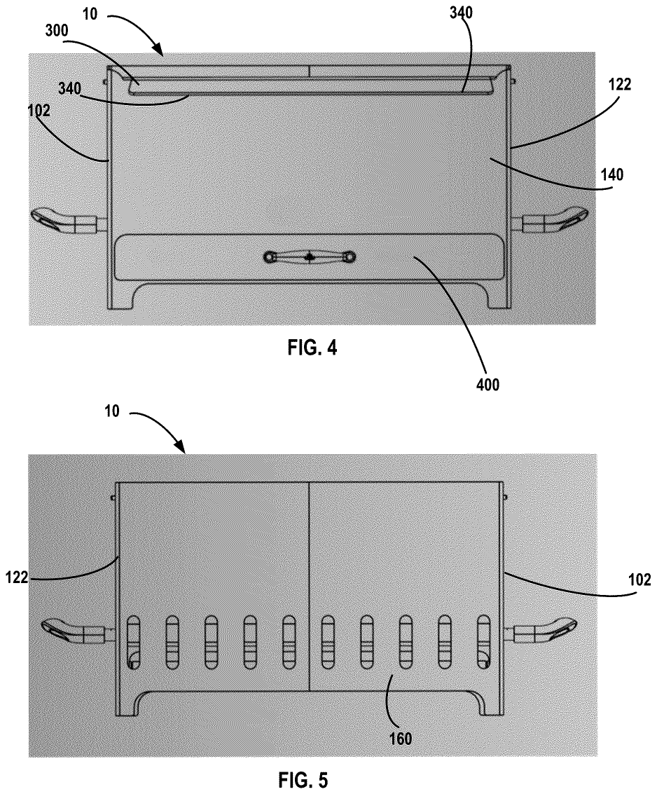

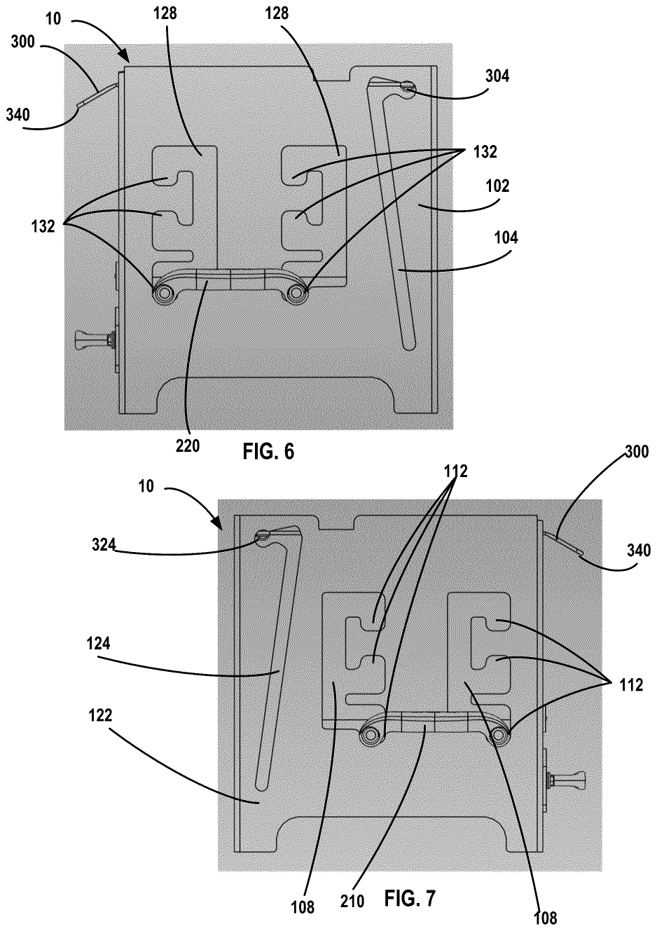

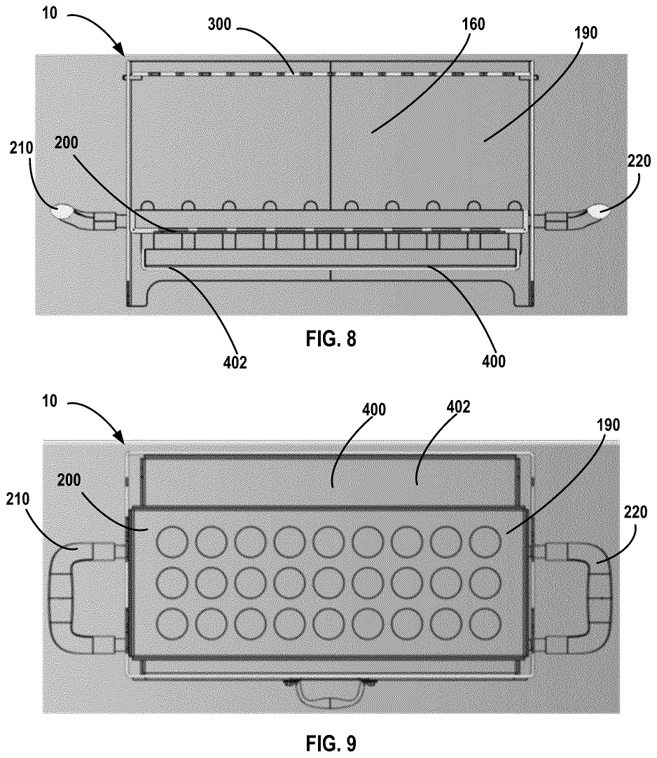

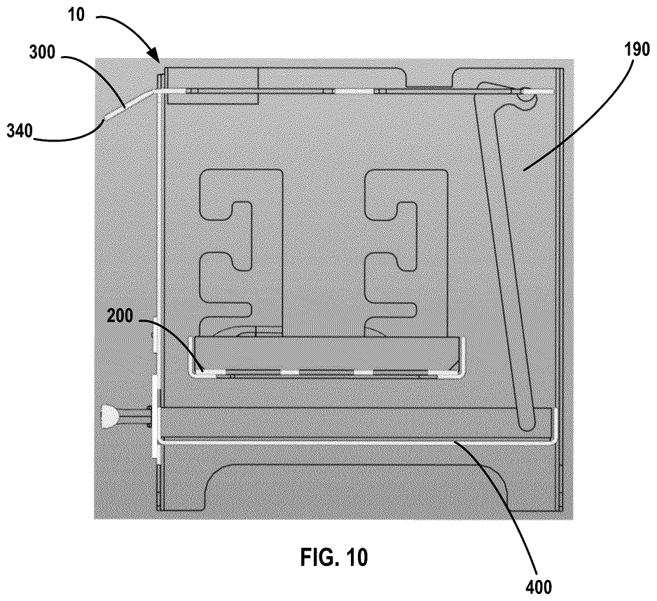

FIGS. 1-12 illustrate an exemplary grill 10. The grill 10 shown in FIGS. 1-12 is most suitable as an outdoor grill and may be a portable or tabletop grill. The grill 10 shown in FIGS. 1-12 is suitable for use with charcoal or other flammable substance including for example pellets, hardwood, and binchotan. However, in other embodiments, other heat sources may be used with the grill 10 including for example gas and propane or an electrical heating element.

As shown in FIGS. 1-12, the grill 10 includes a first sidewall 102, a second sidewall 122, a front wall 140, a back wall 160, and a bottom wall 180. As shown in FIGS. 1-12 the first sidewall 102, the second sidewall 122, the front wall 140, the back wall 160, and the bottom wall 180 may be engaged together to form a structure having an internal compartment 190. As shown in FIGS. 1-12, the first sidewall 102 and the front wall 140 can form a first foot 192, the first sidewall 102 and the back wall 160 can form a second foot 194, the second sidewall 122 and the front wall 140 can form a third foot 196; and the second sidewall 122 and the back wall 160 can form a fourth foot 198. The feet 192, 194, 196, 198 can be configured to allow the grill to be placed on a surface including, for example, a table top. In some examples, the feet 192, 194, 196, 198 may include additional material such as a rubber or silicone cap to allow the grill 10 to more easily rest on a surface.

As shown in FIGS. 1-12 the grill 10 also includes a grill top 300. As will be described in more detail below, the internal compartment 190 can include a tray 200 and/or a drawer 500. The internal compartment 190 may also provide space for the heat source for the grill 10. As described above, the heat source for the grill may be charcoal or other flammable substance including for example pellets hardwood, and binchotan and in other embodiments may be gas or propane or an electrical heating element. Advantageously, and as will be described in more detail below, the internal compartment 190 may provide space for the grill top 300 to be stowed such that another grilling surface can be used with the grill.

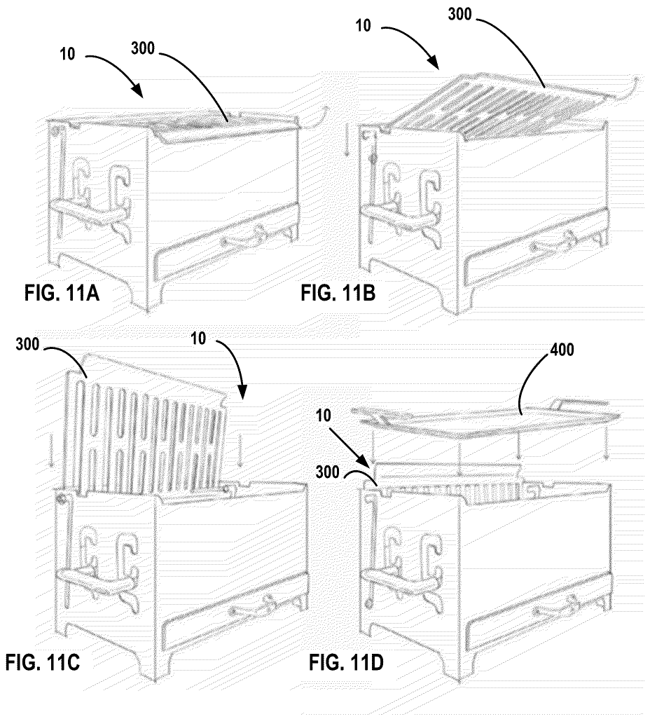

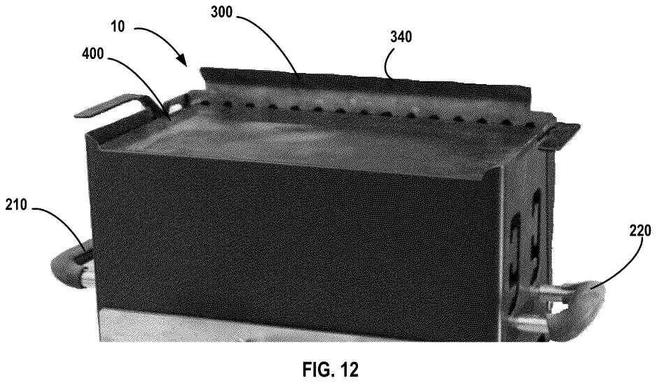

As shown in FIGS. 1-12 the grill 10 may include a grill top 300. As will be described in greater detail below, the grill top 300 may be movable between a grilling position (shown in FIGS. 1-7) and a stowed position (shown in FIGS. 11D and 12). The grill top 300 may have a first edge 302, a second edge 322, a front edge 340, and a back edge 360. As shown in FIGS. 1-12 the front edge 340 of the grill top 300 may be angled downward when the grill top 300 is in the grilling position. In some embodiments, the grill top 300 includes a first peg 304 extending from the first edge 302 and a second peg 324 extending from the second edge 322. In some examples the pegs 304, 324 may be a screw, a bolt, or may be formed as part of the grill top 300. The pegs 304, 324 may correspond to complementary slots located in the first sidewall 102 and the second side wall 104 and facility movement of the grill top 300 between the grilling position and the stowed position. As best shown in FIGS. 1-7, the first sidewall 102 may include a first slot 104 and the second sidewall 104 may have a second slot 124. Each of the slots 104, 124 may be generally shaped like the letter “L” or the number “7”. The pegs 304, 324 may be sized to fit into the corresponding slots 104, 124. As best shown in FIGS. 11A-11D the pegs 304, 324 may slide and rotate within the slots 104, 124 such that the grill top 300 is slidable and rotatable about the pegs 304, 324 and relative to the sidewalls 102, 122 and compartment 190. As shown in FIGS. 11A-11D the grill top 300 is adjustable between a grilling position where the grill top 300 substantially covers the top of the compartment 190 (FIG. 11A), and a stowed position where the grill top 300 is substantially within the compartment 190 in a substantially vertical position (FIG. 11D). In the grilling position the grill top 300 may contact the top edge of the front wall 140 and/or sidewalls 102, 122. As shown in FIG. 11A, the grill top 300 may be engaged in the grilling position wherein the grill top 300 substantially covers the top of the compartment 190. To move the grill top 300 to the stowed position a user may rotate the grill top 300 upwards and then slide the grill top 300 forward and then downward (shown in FIGS. 11B and 11C) such that the pegs 304, 324 slide and rotate within the slots 104, 124. As shown in FIG. 11D, the grill top 300 in the stowed position may be substantially within the compartment 190 and may be substantially in a vertical position. As shown in FIG. 11D, a portion of the grill top 300 may extend above the compartment 190 when the grill top 300 is in the stowed position. In the stowed position, the grill top 300 is located in the space between the tray 200 and the back wall 160 which can be seen in FIG. 9. In the stowed position the front edge 340 of the grill top 300 is vertically above the back edge 360 of the grill top 300.

As shown in FIGS. 11D and 12, the grill 10 can also include a removable griddle 400. As shown in FIGS. 11D and 12 the griddle 400 is configured to engage a top edge of the first sidewall 102 and the second sidewall 122 and/or the front wall 160 and back wall 180. As shown in FIGS. 11D and 12, the griddle 400 may include one or more handles to allow a user to move the griddle 400. The top edges of the grill 10 sidewalls and/or front and back walls may also include engagement features to allow for a more secure engagement between the griddle 400 and the grill 10. As shown for example in FIGS. 11D and 12 the top edge of the sidewalls 102, 122 may include notches that interact with corresponding features, such as the handles, on the griddle 400 to secure the griddle 400 in place. Advantageously when the griddle 400 is engaged with grill 10 the grill top 300 may act as a backstop for food cooking on the griddle. As shown in FIG. 12, when the griddle 400 is engaged with the grill 10 the underside of the grill top 300 may engage with a back edge of the grill top 300. Thus, when a user is cooking items on the griddle 400 the underside of the grill top 300 can be used as a backstop so the user does not accidentally push food off the back of the griddle 400 surface. Additionally, and as shown in FIGS. 11D and 12, the front edge 340 of the grill top 300 may be angled forward when the grill top 300 is in the stowed position. This may also help a user more conveniently cook food on the griddle 400 and reduce the risk of food being pushed off the back of the griddle 400.

While the grill 10 is shown in FIGS. 1-12 having a grill top 300 which is engaged with and movable relative to the sidewalls 102, 122 and also including a removable griddle 400, in other embodiments the cooking surfaces may be reversed. For example, in one embodiment the griddle cooking surface may be engaged with the grill 10 and movable relative to the sidewalls 102, 122, and the grill 10 may include a removable grill top surface. Such an embodiment may be useful for a user who intends to use the griddle surface more than the grill top surface.

As described above, the grill 10 may also include a tray 200. In some examples the tray 200 may be used to hold charcoal or other heat source for the grill 10. Advantageously, the tray 200 may vertically adjustable within the compartment 190 to allow the user to move the heat source closer or further from the grilling surface. As shown in FIGS. 1-12 the tray may include a plurality of holes to allow for air flow and to allow debris to fall through the tray.

The tray 200 may be located within the compartment 190. The tray 200 may have a first handle 210 extending through the first sidewall 102 and a second handle 220 extending through the second side wall 122. In one example, and as shown in FIGS. 1-12 the tray may be vertically adjustable by moving the tray within a system of slots or openings in the sidewalls 102, 122 and engaging the tray within a system of notches. As shown in FIGS. 1-12, the first sidewall 102 includes a first tray engagement opening 108, and the second sidewall 122 includes a second tray engagement opening 128. The first handle 210 extends through the first tray engagement opening 108 and the second handle 220 extends through the second tray engagement opening 128. The first tray engagement opening 108 can include a first plurality of notches 112 and the second tray engagement opening 128 can include a second plurality of notches 132. A user can move the handles 210, 220 up or down the sidewall and the first handle 210 can be configured to engage the first plurality of notches 112 and the second handle 220 can be configured to engage the second plurality of notches 134 to allow the tray 200 to be vertically adjustable within the compartment 190.

As shown in FIGS. 1-12, the grill 10 may also include a drawer 500. The drawer 500 may be located below the tray 200 and below the grill top 300. The drawer may extend through front wall 140, but in other embodiments the drawer may extend through the sidewalls or back wall. As best shown in FIG. 9, the drawer includes a surface 402 that may extend below substantially all of the grill top 300. Any debris that may fall through the grill top 300, griddle 400, and/or tray 200 may land on the drawer surface 402. The user can then remove the drawer 500 from the grill and remove the debris from the surface 402 for easy cleanup.

The various portions of the grill 10 may be formed of any suitable material and may be assembled using any suitable method. In one example, the body of the grill 10 may be formed of carbon steel and the various portions may be welded together. In one embodiment the grill top 300 may be formed of stainless steel and the griddle may be formed of carbon steel.

The various embodiments described herein enable a grill having a movable grill top that is stowable within the grill. It is also understood that in other embodiments, the various devices, components, and features of the grill described herein may be constructed with similar structural and functional elements having different configurations, including different ornamental appearances. Still other benefits may be recognized by those skilled in the art. Accordingly, while the specific embodiments have been illustrated and described, numerous modifications come to mind without significantly departing from the spirit of the invention and the scope of protection is only limited by the scope of the accompanying claims.

What is claimed is:

1. A grill comprising:
a first sidewall, the first sidewall having a first slot;
a second sidewall, the second sidewall having a second slot;
a front wall, the front wall engaged with the first sidewall and the second sidewall;
a back wall, the back wall engaged with the first sidewall and the second sidewall;
a bottom wall;
the first sidewall, second sidewall, the front wall, the back wall, and the bottom wall form an internal compartment;
a grill top, the grill top having a first edge having a first peg extending from the first edge and into the first slot, a second edge having a second peg extending from the second edge and into the second slot, a front edge, and a back edge;
wherein the grill top is adjustable between a grilling position where the grill top substantially covers the top of the compartment, and a stowed position where the grill top is substantially within the compartment in a substantially vertical position.

2. The grill of claim 1, further comprising:
a tray, the tray located within the compartment and having a first handle extending through the first sidewall and a second handle extending through the second side wall, the tray being vertically adjustable within the compartment.

3. The grill of claim 2, wherein the first sidewall includes a first tray engagement opening 108, and wherein the second sidewall includes a second tray engagement opening; and
wherein the first handle extends through the first tray engagement opening and the second handle extends through the second tray engagement opening.

4. The grill of claim 3, wherein the first tray engagement opening comprises a first plurality of notches and the second tray engagement opening comprises a second plurality of notches; and
wherein the first handle is configured to engage the first plurality of notches and the second handle is configured to engage the second plurality of notches to allow the tray to be vertically adjustable within the compartment.

5. The grill of claim 1, wherein the front edge of the grill top is angled downward when the grill top is in the grilling position.

6. The grill of claim 1, wherein the front edge of the grill top is angled forward when the grill top is in the stowed position.

7. The grill of claim 1, wherein the grill top is rotatable within the compartment.

8. The grill of claim 1, wherein the grill top is slidable within the compartment.

9. The grill of claim 1, further comprising a removable griddle that is configured to engage a top edge of the first sidewall and the second sidewall.

10. The grill of claim 1, wherein a portion of the grill top is configured to act as a backstop when the grill top is in the stowed position.

11. The grill of claim 2, further comprising a drawer located below the tray.

12. The grill of claim 11, wherein the drawer extends through the front wall.

13. The grill of claim 1, wherein the first sidewall and the front wall form a first foot, wherein the first sidewall and the back wall form a second foot, wherein the second sidewall and the front wall form a third foot; and wherein the second sidewall and the back wall form a fourth foot.

14. A grill comprising:
a first sidewall;
a second sidewall;
a front wall, the front wall engaged with the first sidewall and the second sidewall;
a back wall, the back wall engaged with the first sidewall and the second sidewall;
a bottom wall;
the first sidewall, second sidewall, the front wall, the back wall, and the bottom wall form an internal compartment;
a grill top, the grill top having a first edge, a second edge, a front edge, and a back edge;
wherein the grill top is adjustable between a grilling position where the grill top substantially covers the top of the compartment, and a stowed position where the grill top is substantially within the compartment in a substantially vertical position.

15. The grill of claim 14, wherein the front edge of the grill top is angled downward when the grill top is in the grilling position.

16. The grill of claim 14, wherein the front edge of the grill top is angled forward when the grill top is in the stowed position.

17. The grill of claim 14, wherein the grill top is engaged with the first sidewall and the second sidewall.

18. The grill of claim 14, wherein the grill top is rotatable and slidable relative to the first sidewall and the second sidewall.

19. A grill comprising:
a first sidewall;
a second sidewall;
a front wall, the front wall engaged with the first sidewall and the second sidewall;
a back wall, the back wall engaged with the first sidewall and the second sidewall;
a bottom wall;
the first sidewall, second sidewall, the front wall, the back wall, and the bottom wall form an internal compartment;
a grill top, the grill top having a first edge, a second edge, a front edge, and a back edge, wherein the grill top is adjustable between a grilling position where the grill top substantially covers the top of the compartment, and a stowed position where the grill top is substantially within the compartment in a substantially vertical position;
a removable griddle that is configured to engage a top edge of the first sidewall and a top edge of the second sidewall when the grill top is in the stowed position.

20. The grill of claim 19, wherein the grill top is rotatable and slidable relative to the first sidewall and the second sidewall.
